(19) United States
(12) Patent Application Publication
(10) Pub. No.: US 2009/0070410 A1
(43) Pub. Date: Mar. 12, 2009

(54) Managing Presence Information Of A Presentity

(75) Inventors: Michael A. Gilfix, Austin, TX (US); Victor S. Moore, Lake City, FL (US); Rhys D. Ulerich, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/854,383

(22) Filed: Sep. 12, 2007

(51) Int. Cl. G06F 15/16

(52) U.S. Cl. 709/203

(57) ABSTRACT

Methods, apparatus, and products for managing presence information of a presentity through a network according to a loosely-coupled network architecture style, the presentity representing a user of the network, are described that include receiving, by the presence information server, a request message to administer presence information of the presentity in a presence information document, the presence information document implemented as a markup document that includes one or more dedicated sections for presence information of the presentity, the request message identifying an action to administer presence information in the presence information document, and an identification of a dedicated section; retrieving, by the presence information server in response to the request message, the presence information document; and modifying, by the presence information server, the presence information document, including administering, in accordance with the request message, the presence information of the presentity in the presence information document.

### CROSS-REFERENCE TO RELATED APPLICATION

This application is related to commonly-assigned application Ser. No. Not Yet Assigned, filed on even date herewith, entitled “Managing Presence Information of a Presentity” and bearing Attorney Docket No. AUS920070488US2, which is hereby incorporated by reference herein in its entirety.

### BACKGROUND OF THE INVENTION

1. Field of the Invention

The field of the invention is data processing, or, more specifically, methods, apparatus, and products for managing presence information of a presentity.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Current computer users often use one or more networked devices. The availability of a user to communicate through a network and any other contextual information about their activities while connected to the network is described as presence information. Such presence information may be made available to other users who may wish to communicate with the user currently present on the network. Current approaches of collecting, disseminating, and modifying presence information, however, are limited to either session initiation protocol (‘SIP’) style interactions or Service Oriented Architecture Protocol (‘SOAP’) Web Services interactions whose interfaces are defined in a Web Service Definition Language (‘WSDL’) document. Session initiation protocol (‘SIP’) style interactions require creation of a session which is often cumbersome in highly scalable Internet-based interactions. Web services interactions require a determination of an appropriate level of abstraction and standardization of interface techniques, which can also be cumbersome in larger networks with many disparate clients. Readers of skill will therefore recognize that room for improvement exists in managing presence information of a presentity through a network.

### SUMMARY OF THE INVENTION

Methods, apparatus, and products for managing presence information of a presentity through a network according to a loosely-coupled network architecture style, the presentity representing a user of the network, are described that include receiving, by the presence information server, a request message to administer presence information of the presentity in a presence information document, the presence information document implemented as a markup document that includes one or more dedicated sections for presence information of the presentity, the request message identifying an action to administer presence information in the presence information document, and an identification of a dedicated section; retrieving, by the presence information server in response to the request message, the presence information document; and modifying, by the presence information server, the presence information document including administering, in accordance with the request message, the presence information of the presentity in the presence information document.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for managing presence information of a presentity according to embodiments of the present invention.

FIG. 2 sets forth a block diagram of automated computing machinery comprising an exemplary presence information server useful in managing presence information of a presentity according to embodiments of the present invention.

FIG. 3 sets forth a flow chart illustrating an exemplary method for managing presence information of a presentity according to embodiments of the present invention.

FIG. 4 sets forth a flow chart illustrating a further exemplary method for managing presence information of a presentity according to embodiments of the present invention.

FIG. 5 sets forth a flow chart illustrating a further exemplary method for managing presence information of a presentity according to embodiments of the present invention including retrieving, from a dedicated section identified by a URI, presence information.

FIG. 6 sets forth a flow chart illustrating a further exemplary method for managing presence information of a presentity according to embodiments of the present invention.

FIG. 7 sets forth a flow chart illustrating a further exemplary method for managing presence information of a presentity according to embodiments of the present invention.

FIG. 8 sets forth a flow chart illustrating a further exemplary method for managing presence information of a presentity according to embodiments of the present invention.

FIG. 9 sets forth a flow chart illustrating a further exemplary method for managing presence information of a presentity according to embodiments of the present invention.

### DETAILED DESCRIPTION OF EXEMPLARY EMBODIMENTS

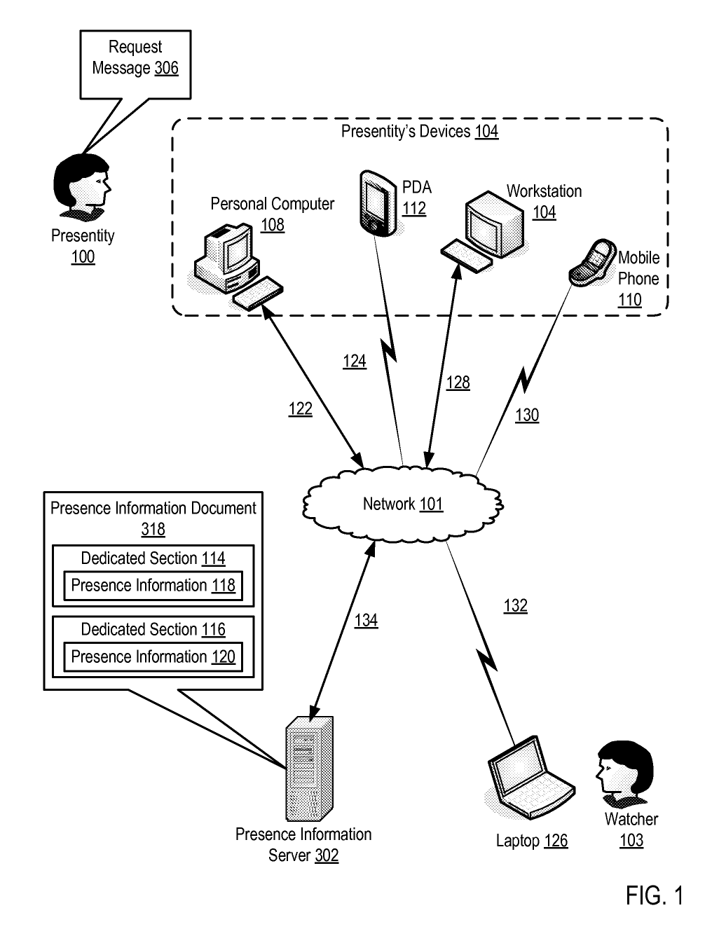

Exemplary methods, apparatus, and products for managing presence information of a presentity in accordance with the present invention are described with reference to the accompanying drawings, beginning with FIG. 1. FIG. 1 sets forth a network diagram of a system for managing presence information of a presentity according to embodiments of the present invention. The presentity (100) of FIG. 1 represents a user of the network (101). Presentities may communicate through the network (101) by using any number of devices. The presentity (100) of FIG. 1, for example, communicates through the network (101) by using such devices (104) as:
a personal computer (108) which is coupled for data communications to the network (101) through wireline connection (122);
a personal digital assistant (‘PDA’) (112) which is coupled for data communications to the network (101) by wireless connection (124);
a workstation (104) which is coupled for data communications to the network (101) by wireline connection (128); and
a mobile phone (110) which is coupled for data communications to the network (101) by wireless connection (128).

A presentity (100) is described by presence information (118, 120) contained in a presence information document. Presence information, in computer and telecommunications networks, is a status indicator that conveys to a watcher the availability and willingness of a presentity to communicate with other network users.

Presence information may, for example, indicate the status of a user of an instant messaging client as “away,” “busy,” or “idle.” Presence information may change from time to time when a presentity's availability to communicate to other network users through any device changes.

The presence information of a presentity may correspond to any of the presentity's devices (104). For example, presence information corresponding to the presentity's (100) personal computer (108) may describe the status of the personal computer as ‘closed’ while presence information corresponding to the presentity's (100) work station (104) may describe the status of the work station as ‘open.’ Such presence information of the presentity, when taken as a whole, represents that the presentity is at work, away from the presentity's personal computer, but capable of communicating through the presentity's workstation.

In the system of FIG. 1 the presence information is conveyed to a watcher (103) through the network (101). A watcher is a user of the network that observes the presence information of a presentity. The watcher (103) may observe the presence information of the presentity (101) through the network (101) to determine the availability of the presentity to communicate through one of the presentity's networked devices. In the example of FIG. 1, the watcher (103) observes the presence information of the presentity (100) through the use of the laptop (126) which is coupled for data communications to the network (101) through wireless connection (132).

The system of FIG. 1 is capable of managing presence information of a presentity through the network according to a loosely-coupled network architecture style, such as for example, the REST network architecture style. The term ‘REST’ is a term used to describe an architecture style of networked systems. REST is an acronym standing for Representational State Transfer. A REST network architecture is typically characterized by:
A client-server, pull-based interaction style in which clients pull representations of resources from servers.
A uniform resource interface that provides access to all resources using a generic interface, such as for example, through HyperText Transfer Protocol (‘HTTP’) GET, POST, PUT, and DELETE requests.
Resources in the networked system which are named using a URI.
Representations of resources that are interconnected using URIs. URIs within REST may be constructed in such a manner as to navigate, or index into structured representations of resource entities.
Layered components such as proxy servers, cache servers, gateways, and others, that can be inserted between clients and resources to support performance and security.

As mentioned above the system of FIG. 1 operates generally for managing presence information of a presentity according to embodiments of the present invention. The system of FIG. 1 is capable of receiving, by the presence information server (302) from the presentity (100), a request message (306) to administer presence information of the presentity (100) in a presence information document (318), the presence information document implemented as a markup document that includes one or more dedicated sections (114,116) for presence information (118,120) for the presentity (100), the request message (306) identifying an action to administer presence information in the presence information document, and an identification of a dedicated section; retrieving, by the presence information server (302) in response to the request message (306), the presence information document (318); and modifying, by the presence information server, the presence information document including administering, in accordance with the request message (306), the presence information of the presentity (100) in the presence information document (318).

A presence information server may be a computer, or other automated computing machinery, capable of administering and storing presence information documents. A presence information server may store many presence information documents, each presence information document associated with a different presentity. That is, any number of users of the network (101) may provide their own presence information to watchers through the presence information server. The presence information server (302) is coupled for data communications to the network through wireline connection (134) and includes presence information of a presentity (100) in presence information document (318).

A presence information document is a document that includes presence information for a presentity. The exemplary presence information document (318) of FIG. 1 is implemented as a markup document that includes one or more dedicated sections (114,116) for presence information (118,120) for the presentity (100). Each dedicated section (114,116) in a presence information document may include presence information corresponding to one of the presentity's devices (104). For example, one dedicated section may include presence information corresponding to the presentity's PDA (112), while another dedicated section includes presence information corresponding to the presentity's mobile phone (110).

Consider for further explanation the following exemplary presence information document implemented as an extensible markup language (‘XML’) document:

```
<?xml version=“1.0” encoding=“UTF-8”?>
<presence entity=“Brandon”>
    <note>Out of Office. Call my cell.</note>
<tuple id=“MyCellPhone”>
    <status>
        <basic>open</basic>
    </status>
    <contact>555-555-5555</contact>
</tuple>
<tuple id=”MyWorkEmail”>
    <status>
        <basic>closed</basic>
    </status>
    <contact>mailto:brandon@example.com</contact>
</tuple>
</presence>
```

In the XML example above, the presence information document includes a <presence entity> tag that identifies the user represented by the presentity. The presentity in the example above is identified as “Brandon.”

Also in the XML example above, the presence information document includes a <note> tag identifying text that the presentity, Brandon, intends for watchers of the Brandon's presence information to read. In this example, the note represents that Brandon is out of the office and can be reached on his cell phone.

Also in the XML example above, the presence information document includes two <tuple> tags, each tag identifying presence information for one of Brandon's networked devices. In this example, the <tuple> tag, <tuple id=“MyCellPhone”>, identifies presence information corresponding to Brandon's cell phone. The <tuple> tag, <tuple id=“MyWorkEmail”>, identifies presence information corresponding to Brandon's work email address.

Also in the XML example above, each <tuple> tag includes a dedicated section, identified by the <status> tag, describing the status of a device and contact information of the device. In this example, the <status> tag for Brandon's Cell phone identifies the status of the cell phone as “open.” Also in this example, the <status> tag for Brandon's work email describes the status of Brandon's work email as closed.

Also in the XML example above, each <tuple> tag also includes a dedicated section, identified by the <contact> tag, identifying the contact information corresponding to a device. In this example, the <contact> tag corresponding to Brandon's cell phone identifies a phone number, 555-555-5555, as contact information for the cell phone. Also in this example, the <contact> tag corresponding to Brandon's work email identifies an email address, brandon@example.com, as contact information for the cell phone.

In the system of FIG. 1, receiving, by the presence information server (302), a request message (306) to administer presence information of the presentity (100) in a presence information document (318), may be carried out by receiving, from the presentity (100) through the network (101), a HyperText Transfer Protocol (‘HTTP’) request message. HTTP request messages include a method, such as GET, PUT, POST, or DELETE, and a uniform resource identifier (‘URI’) identifying a resource. In systems that manage presence information according to embodiments of the present invention, the URI may identify one or more dedicated sections of a presence information document or identify the presence information document itself. In addition to the method and URI, HTTP request messages may also include a message body. Message bodies may include presence information to insert into a new dedicated section in a presence information document or updated presence information to replace presence information in a dedicated section of a presence information document.

A URI useful for managing presence information of a presentity according to embodiments of the present invention is a compact string of characters used to identify or name a resource. The primary purpose of a URI generally is to enable interaction with representations of the resource over a network, typically the World Wide Web, using specific protocols. Expressions of URIs are defined according to protocols, such as for example, the HTTP protocol. Exemplary URIs are described in this specification as URIs expressed according to the HTTP protocol for clarity only, not for limitation. Those of skill in the art will immediately recognize that URIs useful for managing presence information of a presentity according to embodiments of the present invention may be constructed in other ways. URIs may also be constructed, for example, according to the XPath expression language. Xpath, XML Path Language, is an expression language for addressing portions of an XML document or for computing values, such as strings, numbers, or boolean values, based on the content of an XML document. The XPath language is based on a tree representation of the XML document, and provides the ability to navigate around the tree, selecting nodes by a variety of criteria.

The presence information server (302) of FIG. 1 is capable of receiving a request message to administer presence information of the presentity in a presence information document and in response to the request message (306) retrieving a presence information document (318). The presence information server of FIG. 1 is capable of retrieving a presence information document (318) by moving the presence information document from a storage media into the presence information server's computer memory, such as Random Access Memory (‘RAM’). Presence information documents may be stored in any storage media, such as, a local hard disk drive, RAID array, external disk drive, or any other storage media as will occur to those of skill in the art.

In the system of FIG. 1, the presence information server is also capable of administering, in accordance with the request message, the presence information of the presentity in the presence information document. The presence information server (302) of FIG. 1 is capable of administering, in accordance with the request message (306), the presence information of the presentity (100) in the presence information document (318) in various ways, in dependence upon the action identified in the request message. Such ways of administering presence information may include, for example, creating a new dedicated section in the presence information document and inserting presence information in the new dedicated section, deleting presence information from a dedicated section, modifying presence information at a dedicated section, or retrieving presence information from a dedicated section.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

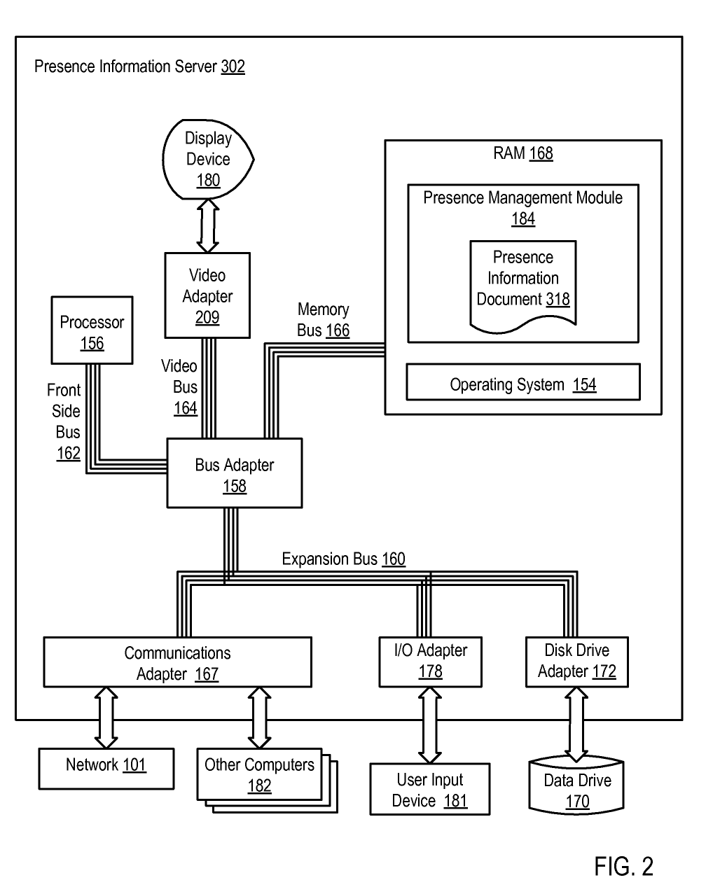

Managing presence information of a presentity in accordance with the present invention is generally implemented with computers, that is, with automated computing machinery. In the system of FIG. 1, for example, the devices (104), presence information server (302), and laptop (126) are implemented to some extent at least as computers. For further explanation, therefore, FIG. 2 sets forth a block diagram of automated computing machinery comprising an exemplary presence information server (302) useful in managing presence information of a presentity according to embodiments of the present invention. The presence information server (302) of FIG. 2 includes at least one computer processor (156) or ‘CPU’ as well as random access memory (168) (‘RAM’) which is connected through a high speed memory bus (166) and bus adapter (158) to processor (156) and to other components of the presence information server (302).

Stored in RAM (168) is presence management module. The presence management module includes computer program instructions for managing presence information of a presentity according to embodiments of the present invention. The presence management module (184) is capable of receiving, by the presence information server (302) from the presentity, a request message (306) to administer presence information of the presentity (100) in a presence information document (318), the presence information document implemented as a markup document that includes one or more dedicated sections for presence information for the presentity, the request message (306) identifying an action to administer presence information in the presence information document, and an identification of a dedicated section; retrieving, by the presence information server (302) in response to the request message (306), the presence information document (318); and modifying, by the presence information server, the presence information document including administering, in accordance with the request message (306), the presence information of the presentity in the presence information document (318).

Also stored in RAM (168) is an operating system (154). Operating systems useful managing presence information of a presentity according to embodiments of the present invention include UNIX™, Linux™, Microsoft XP™, Microsoft Vista™, AIX™, IBM's i5/OS™, and others as will occur to those of skill in the art. The operating system (154), presence management module (184), and presence information document (318) in the example of FIG. 2 are shown in RAM (168), but many components of such software typically are stored in non-volatile memory also, such as, for example, on a disk drive (170).

The presence information server (302) of FIG. 2 includes disk drive adapter (172) coupled through expansion bus (160) and bus adapter (158) to processor (156) and other components of the presence information server (302). Disk drive adapter (172) connects non-volatile data storage to the presence information server (302) in the form of disk drive (170). Disk drive adapters useful in computers for managing presence information of a presentity according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example presence information server (302) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example presence information server (302) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary presence information server (302) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for managing presence information of a presentity according to embodiments of the present invention include modems for wired dial-up communications, Ethernet (IEEE 802.3) adapters for wired data communications network communications, and 802.11 adapters for wireless data communications network communications.

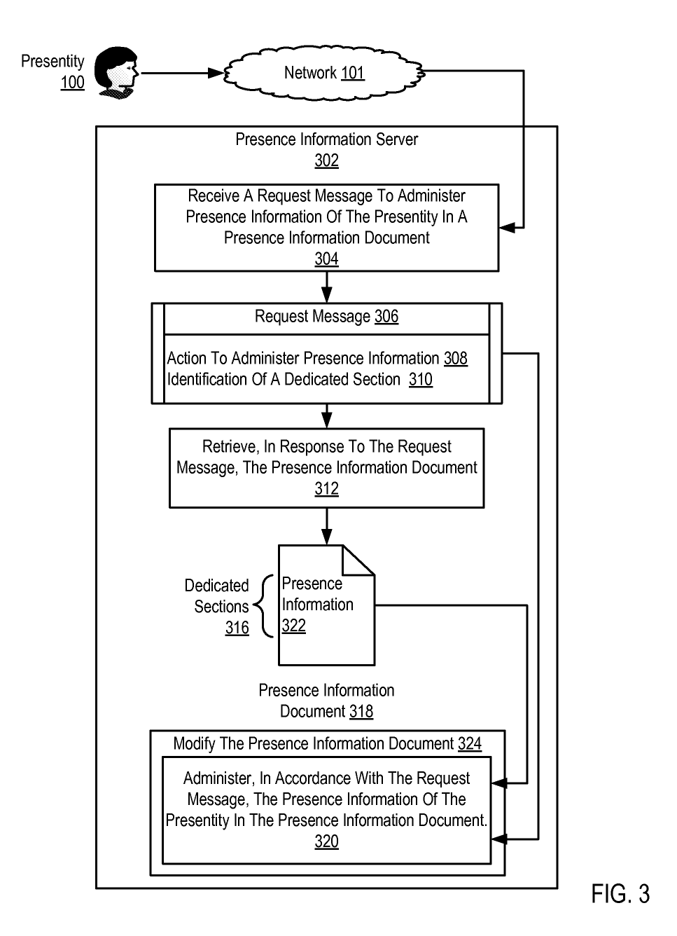

For further explanation, FIG. 3 sets forth a flow chart illustrating an exemplary method for managing presence information of a presentity according to embodiments of the present invention. In the method of FIG. 3 the presentity (100) represents a user of the network (101). The presence information (322) of the presentity (100) in method of FIG. 3 is managed through the network (101) according to a loosely-coupled network architecture style, such as for example, the REST network architecture style.

The method of FIG. 3 includes receiving (304), by the presence information server (302), a request message (306) to administer presence information (322) of the presentity (100) in a presence information document (318). Receiving (304), by the presence information server (302), a request message (306) to administer presence information (322) of the presentity (100) in a presence information document (318), may be carried out by receiving, from the presentity (100) through the network (101), an HTTP request message. HTTP request messages include a method, such as GET, PUT, POST, or DELETE, and a uniform resource identifier (‘URI’) identifying a resource. In addition to the method and URI, HTTP request messages may also include a message body.

The method of FIG. 3 also includes retrieving (312), by the presence information server (302) in response to the request message (306), the presence information document (318). Retrieving (312), by the presence information server (302) in response to the request message (306), the presence information document (318) may be carried out by moving the presence information document from a storage media into computer memory, such as RAM, of the presence information server. Presence information documents may be stored in any storage media, such as, a local hard disk drive, RAID array, external disk drive, or any other storage media as will occur to those of skill in the art.

The method of FIG. 3 also includes modifying (324), by the presence information server (302), the presence information document (318), including administering (320), in accordance with the request message (306), the presence information of the presentity (100) in the presence information document (318). Administering (320), by the presence information server (302) in accordance with the request message (306), the presence information of the presentity (100) in the presence information document (318) may be carried out in various ways, in dependence upon the action (308) identified in the request message (306), including, for example, creating a new dedicated section in the presence information document and inserting presence information in the new dedicated section, deleting presence information from a dedicated section, modifying presence information at a dedicated section, or retrieving presence information from a dedicated section.

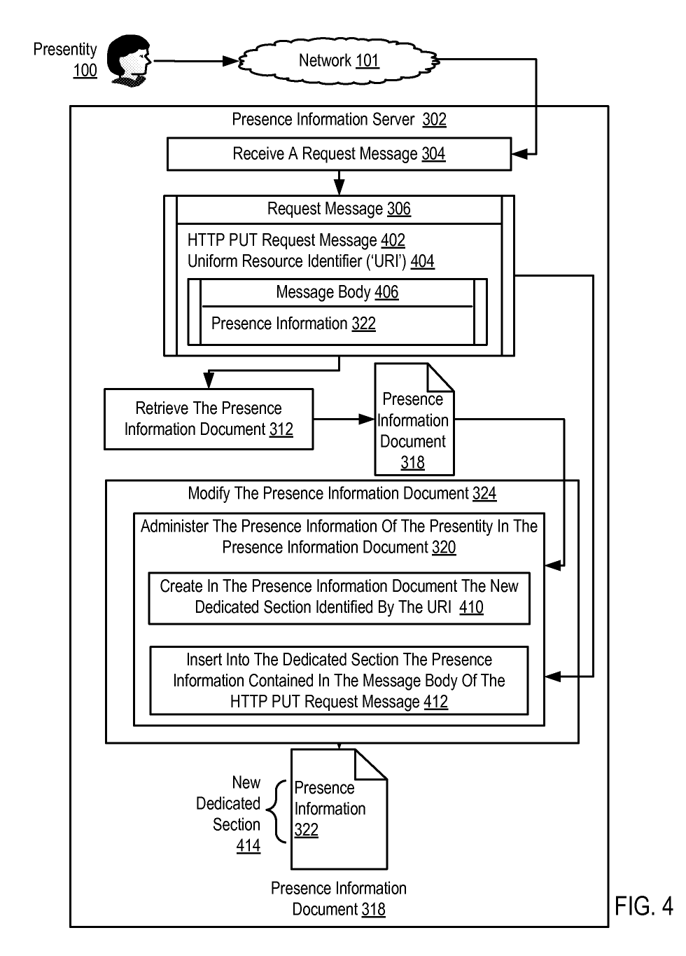

For further explanation, FIG. 4 sets forth a flow chart illustrating a further exemplary method for managing presence information of a presentity according to embodiments of the present invention. The method of FIG. 4 is similar to the method of FIG. 3 in that the method of FIG. 4 also includes receiving (304), by the presence information server (302), a request message (306) to administer presence information (322) of the presentity (100) in a presence information document (318), the presence information document (318) implemented as a markup document that includes one or more dedicated sections (316) for presence information (322) of the presentity (322), the request message identifying an action (308) to administer presence information in the presence information document, and an identification (310) of a dedicated section; retrieving (312), by the presence information server (302) in response to the request message (306), the presence information document (318); and modifying (324), by the presence information server, the presence information document including administering (320), in accordance with the request message (306), the presence information (322) of the presentity (100) in the presence information document (318).

The method of FIG. 4 differs from the method of FIG. 3, however, in that, in the method of FIG. 4 the request message (306) to administer presence information of the presentity in a presence information document is an HTTP PUT request message (402) having a message body (406) that includes the presence information (322) of the presentity (100) and a uniform resource identifier (‘URI’) (404) that identifies a new dedicated section (414) of the presence information document (318). Also in the method of FIG. 4, administering (320), by the presence information server (302) in accordance with the request message (306), the presence information of the presentity in the presence information document (318) is carried out by creating (410) in the presence information document (318) the new dedicated section (414) identified by the URI (404) and inserting (412) into the new dedicated section (414) the presence information (322) contained in the message body (406) of the HTTP PUT request message (402).

Consider, for example, the HTTP PUT request message and URI, HTTP PUT /Brandon/MyCellPhone/status/basic having a message body containing the presence information, ‘open.’ If the presence information document for the presentity ‘Brandon’ does not contain a dedicated section corresponding to ‘MyCellPhone,’ the presence information server, upon receiving the HTTP PUT request message, will create a new dedicated section for ‘MyCellPhone.’ Within the ‘MyCellPhone’ section the presence information server will also create a dedicated section for the ‘status’ of ‘MyCellPhone.’ Within the ‘status’ section the presence information server will also create a dedicated section called ‘basic.’ After creating the new dedicated sections in the presence information document, the presence information server will then insert into the new dedicated section called ‘basic’ the presence information contained in the message body of the HTTP PUT request message, ‘open.’ Such new dedicated sections, including the inserted presence information, may be represented by the following exemplary XML code:

```
<presence entity=“Brandon”>
<tuple id=“MyCellPhone”>
    <status>
        <basic>open</basic>
    </status>
</tuple>
</presence>
```

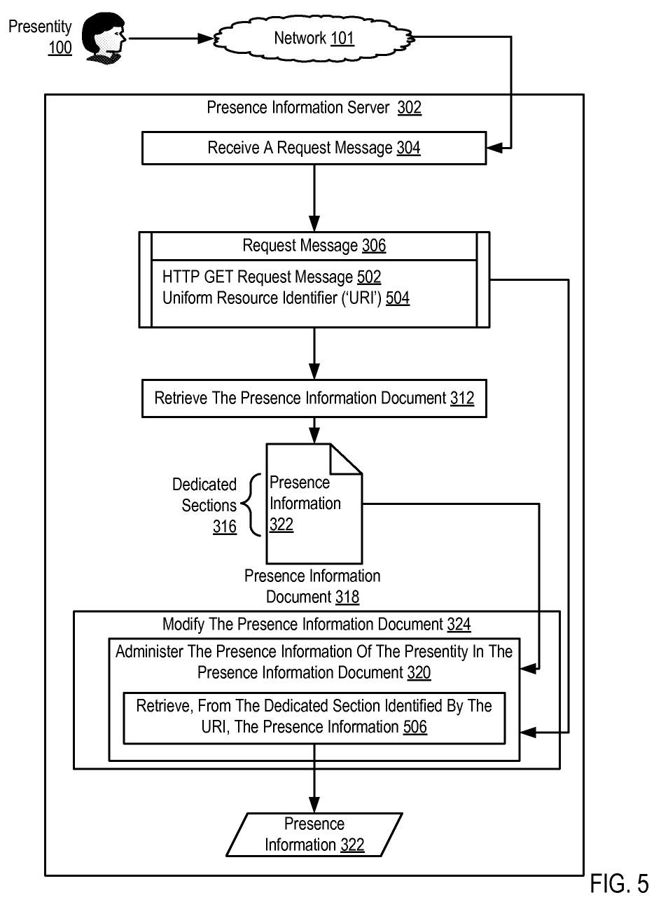

For further explanation, FIG. 5 sets forth a flow chart illustrating a further exemplary method for managing presence information of a presentity according to embodiments of the present invention. The method of FIG. 5 is similar to the method of FIG. 3 in that the method of FIG. 5 includes receiving (304), by the presence information server (302), a request message (306) to administer presence information (322) of the presentity (100) in a presence information document (318), the presence information document (318) implemented as a markup document that includes one or more dedicated sections (316) for presence information (322) of the presentity (322), the request message identifying an action (308) to administer presence information in the presence information document, and an identification (310) of a dedicated section; retrieving (312), by the presence information server (302) in response to the request message (306), the presence information document (318); and modifying (324), by the presence information server, the presence information document including administering (320), in accordance with the request message (306), the presence information (322) of the presentity (100) in the presence information document (318).

The method of FIG. 5 differs from the method of FIG. 3, however, in that, in the method of FIG. 5 the request message (306) to administer presence information of the presentity (100) in a presence information document (318) is an HTTP GET request message (502) and a URI (504) that identifies a dedicated section (316) of the presence information document (318). Also in the method of FIG. 5, administering (320), by the presence information server (302) in accordance with the request message (306), the presence information of the presentity in the presence information document (318) is carried out by retrieving (506), from the dedicated section identified by the URI (504), the presence information (322).

Consider, for example, the HTTP GET request message and URI, HTTP GET /Brandon/MyCellPhone/status/basic. The presence information server retrieves, according to the exemplary HTTP GET request message and URI, the basic status of Brandon's cell phone, ‘open,’ from the following exemplary XML representation of Brandon's presence information document:

```
<?xml version=“1.0” encoding=“UTF-8”?>
<presence entity=“Brandon”>
    <note>Out of Office. Call my cell.</note>
<tuple id=“MyCellPhone”>
    <status>
        <basic>open</basic>
    </status>
    <contact>555-555-5555</contact>
</tuple>
</presence>
```

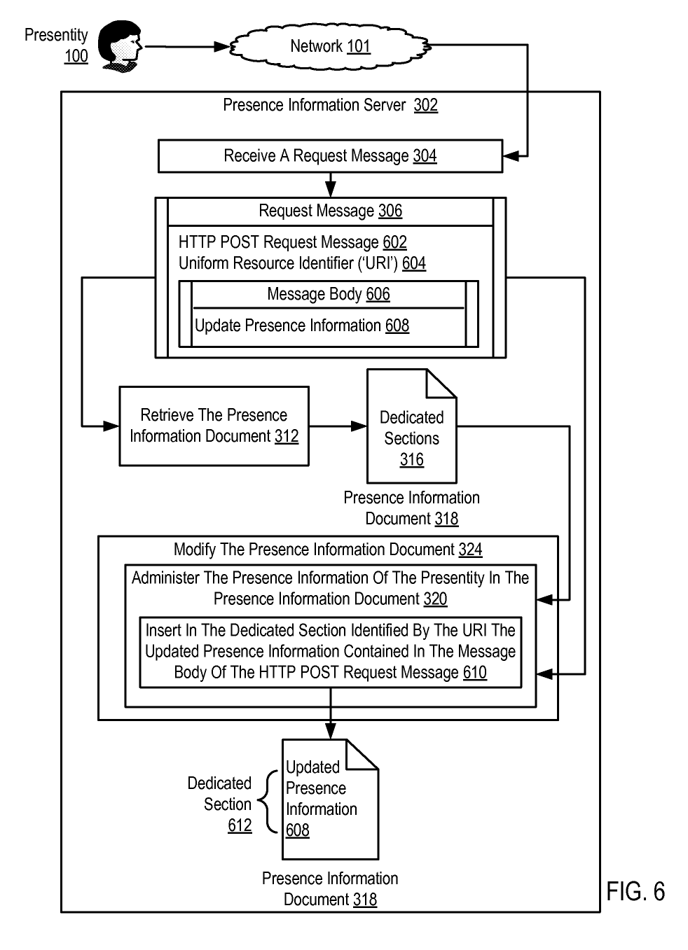

For further explanation, FIG. 6 sets forth a flow chart illustrating a further exemplary method for managing presence information of a presentity according to embodiments of the present invention. The method of FIG. 6 is similar to the method of FIG. 3 in that the method of FIG. 6 includes receiving (304), by the presence information server (302), a request message (306) to administer presence information (322) of the presentity (100) in a presence information document (318), the presence information document (318) implemented as a markup document that includes one or more dedicated sections (316) for presence information (322) of the presentity (322), the request message identifying an action (308) to administer presence information in the presence information document, and an identification (310) of a dedicated section; retrieving (312), by the presence information server (302) in response to the request message (306), the presence information document (318); and modifying (324), by the presence information server, the presence information document including administering (320), in accordance with the request message (306), the presence information (322) of the presentity (100) in the presence information document (318).

The method of FIG. 6 differs from the method of FIG. 3, however, in that, in the method of FIG. 6 the request message (306) to administer presence information of the presentity (100) in a presence information document (318) is an HTTP POST request message (602) having a message body (606) that includes updated presence information (608) of the presentity (100) and a URI (604) that identifies a dedicated section (612) of the presence information document (318). Also in the method of FIG. 6, administering (320), by the presence information server (302) in accordance with the request message (306), the presence information of the presentity in the presence information document (318) is carried out by inserting (610) in the dedicated section (612) identified by the URI (604) the updated presence information (608) contained in the message body (606) of the HTTP POST request message (602).

Consider, for example, the HTTP POST request message and URI, HTTP POST /Brandon/MyPhone/status/basic having a message body containing the presence information, ‘open.’ If the basic status of Brandon's phone is represented as ‘closed’ in Brandon's presence information document, the presence information server, upon receiving the HTTP POST request message, will insert the updated presence information contained in the message body of the HTTP POST request message, ‘open.’ That is, the presence information server will change the basic status of Brandon's ‘MyPhone’ device from ‘closed’ to ‘open.’

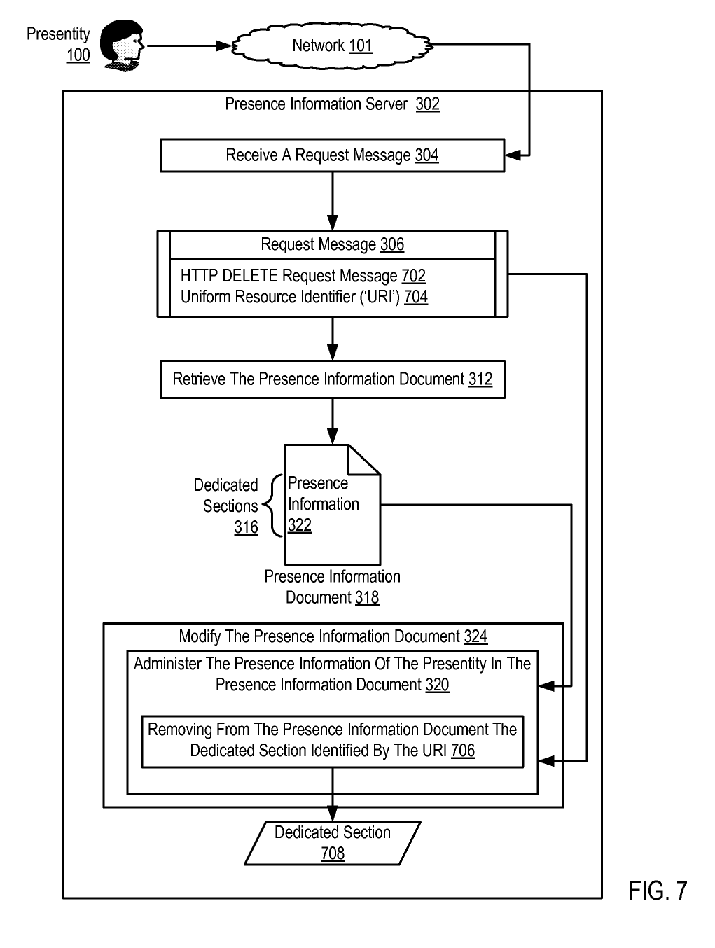

For further explanation, FIG. 7 sets forth a flow chart illustrating a further exemplary method for managing presence information of a presentity according to embodiments of the present invention. The method of FIG. 7 is similar to the method of FIG. 3 in that the method of FIG. 7 includes receiving (304), by the presence information server (302), a request message (306) to administer presence information (322) of the presentity (100) in a presence information document (318), the presence information document (318) implemented as a markup document that includes one or more dedicated sections (316) for presence information (322) of the presentity (322), the request message identifying an action (308) to administer presence information in the presence information document, and an identification (310) of a dedicated section; retrieving (312), by the presence information server (302) in response to the request message (306), the presence information document (318); and modifying (324), by the presence information server, the presence information document including administering (320), in accordance with the request message (306), the presence information (322) of the presentity (100) in the presence information document (318).

The method of FIG. 7 differs from the method of FIG. 3, however, in that, in the method of FIG. 7, the request message (306) to administer presence information of the presentity (100) in a presence information document (118) is an HTTP DELETE request message (702) and a URI (704) that identifies a dedicated section (708) of the presence information document (318). Also in the method of FIG. 7, administering (320), by the presence information server (302) in accordance with the request message (306), the presence information of the presentity in the presence information document (318) is carried out by removing (706) from the presence information document (318) the dedicated section (708) identified by the URI (704).

Consider, for example, the HTTP DELETE request message and URI, HTTP DELETE /Brandon/MyCellPhone. Receiving such an HTTP DELETE request message causes a presence information server to remove, from Brandon's presence information document, the dedicated section identified as ‘MyCellPhone.’Consider also the following exemplary XML representation of such a dedicated section identified as ‘MyCellPhone’ in Brandon's presence information document:

```
<tuple id=“MyCellPhone”>
    <status>
        <basic>open</basic>
    </status>
    <contact>555-555-5555</contact>
</tuple>
```

Assume that this exemplary dedicated section for ‘MyCellPhone’ is one of many dedicated sections in Brandon's presence information document. When the presence information server receives the above exemplary HTTP DELETE request message, the presence information server removes the entire dedicated section for ‘MyCellPhone’ from the presence information document including any children sections, such as ‘status,’ ‘basic,’ and ‘contact.’

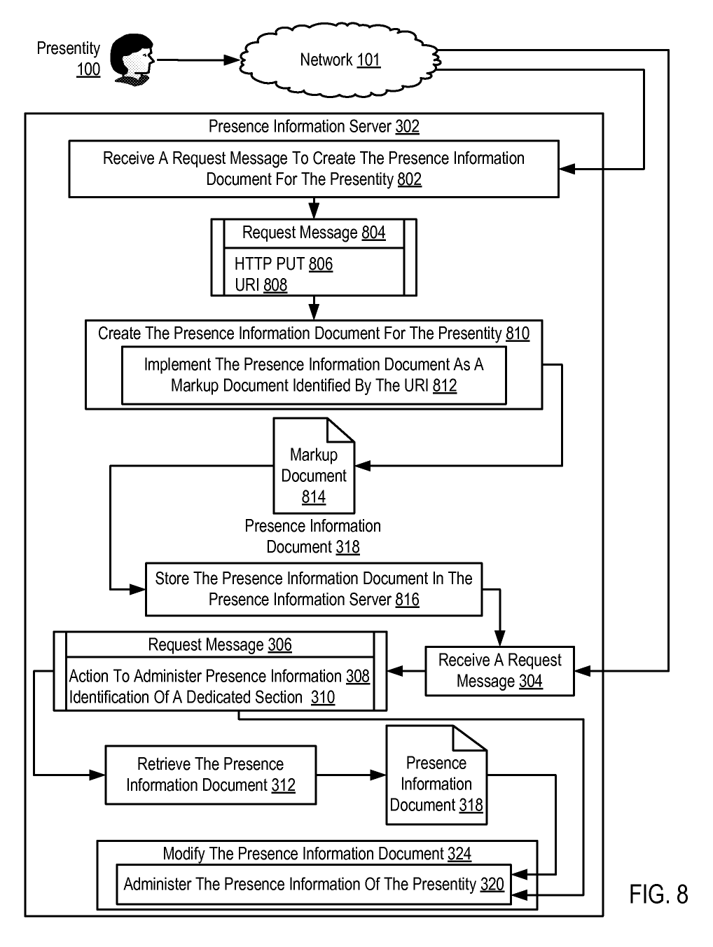

For further explanation, FIG. 8 sets forth a flow chart illustrating a further exemplary method for managing presence information of a presentity according to embodiments of the present invention. The method of FIG. 8 is similar to the method of FIG. 3 in that the method of FIG. 8 includes receiving (304), by the presence information server (302), a request message (306) to administer presence information (322) of the presentity (100) in a presence information document (318), the presence information document (318) implemented as a markup document that includes one or more dedicated sections (316) for presence information (322) of the presentity (322), the request message identifying an action (308) to administer presence information in the presence information document, and an identification (310) of a dedicated section; retrieving (312), by the presence information server (302) in response to the request message (306), the presence information document (318); and modifying (324), by the presence information server, the presence information document including administering (320), in accordance with the request message (306), the presence information (322) of the presentity (100) in the presence information document (318).

The method of FIG. 8 differs from the method of FIG. 3, however, in that, the method of FIG. 8 also includes receiving (802), by the presence information server (302), a request message (804) to create the presence information document (318) for the presentity (100); creating (810), by the presence information server (302) in response to receiving the request message (804), the presence information document (318) for the presentity (100); and storing (816) the presence information document (318) in the presence information server (302).

In the method of FIG. 8, the request message (804) to create the presence information document (3178) is an HTTP PUT request message (806) and a URI (808) that identifies the presence information document (318). Consider the following as an example of such an HTTP PUT request message and URI, HTTP PUT /Brandon. This example HTTP PUT request message identifies a presence information document to be created as the presence information document of a presentity named Brandon.

Also in the method of FIG. 8, creating (810), by the presence information server (302) in response to receiving the request message (804), the presence information document (318) for the presentity (100) is carried out by implementing (812) the presence information document (318) as a markup document identified by the URI. For example, a presence information document is implemented as the following XML code when the presence information server receives HTTP PUT /Brandon:

<?xml version=“1.0” encoding=“UTF-8”?>
<presence entity=“Brandon”>
</presence>

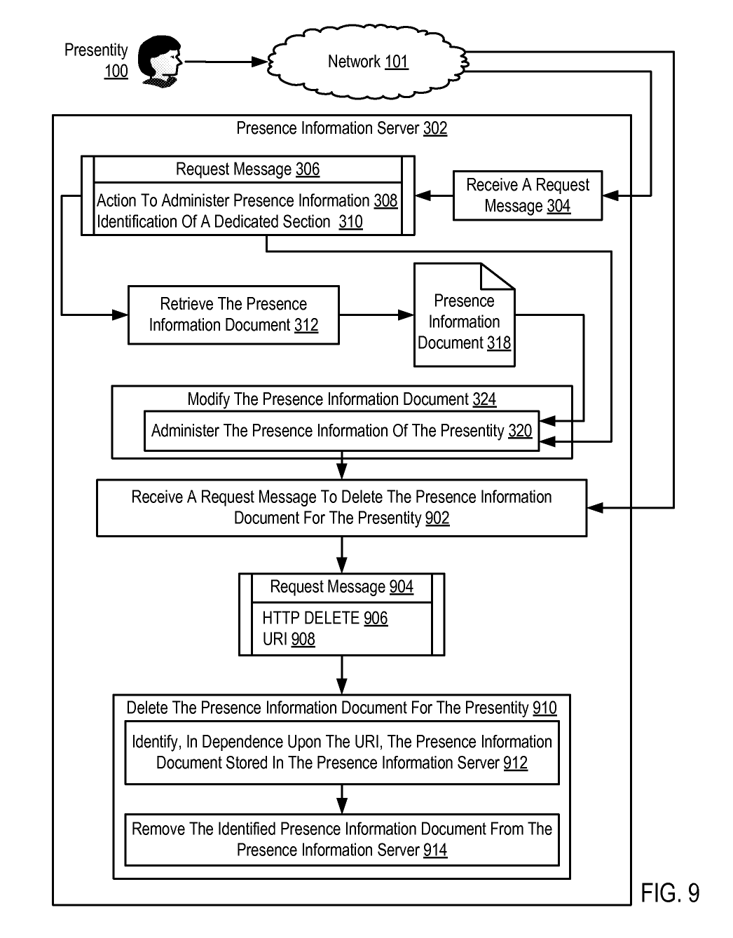

For further explanation, FIG. 9 sets forth a flow chart illustrating a further exemplary method for managing presence information of a presentity according to embodiments of the present invention. The method of FIG. 9 is similar to the method of FIG. 3 in that the method of FIG. 9 includes receiving (304), by the presence information server (302), a request message (306) to administer presence information (322) of the presentity (100) in a presence information document (318), the presence information document (318) implemented as a markup document that includes one or more dedicated sections (316) for presence information (322) of the presentity (322), the request message identifying an action (308) to administer presence information in the presence information document, and an identification (310) of a dedicated section; retrieving (312), by the presence information server (302) in response to the request message (306), the presence information document (318); and modifying (324), by the presence information server, the presence information document including administering (320), in accordance with the request message (306), the presence information (322) of the presentity (100) in the presence information document (318).

The method of FIG. 9 differs from the method of FIG. 3, however, in that, the method of FIG. 9 also includes receiving (902), by the presence information server (302), a request message (904) to delete the presence information document (318) for the presentity (100); and deleting (910), by the presence information server (302) in response to receiving the request message (904), the presence information document (318) for the presentity (100).

In the method of FIG. 9, the request message (904) to delete the presence information document is an HTTP DELETE request message (906) and a URI (908) that identifies the presence information document (318). Consider the following as an example of such an HTTP DELETE request message and URI, HTTP DELETE /Brandon. This example HTTP DELETE request message identifies a presence information document to be deleted as the presence information document of a presentity named Brandon.

In the method of FIG. 9, deleting (910), by the presence information server (302) in response to receiving the request message (306), the presence information document (318) for the presentity (100) is carried out by identifying (912), in dependence upon the URI (908), the presence information document (318) stored in the presence information server (302) and removing (914) the identified presence information document (318) from the presence information server (302). Using the exemplary HTTP DELETE request message above, HTTP DELETE /Brandon, a presence information server deletes the presence information document by identifying the presence information document for the presentity named Brandon and removing that identified presence information document from the presence information server. An entire presence document including any dedicated sections within the presence document can be deleted by using only a single HTTP DELETE request message and a URI identifying the presence information document.

Exemplary embodiments of the present invention are described largely in the context of a fully functional computer system for managing presence information of a presentity. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. An apparatus for managing presence information of a presentity through a network according to a loosely-coupled network architecture style, the presentity representing a user of the network, the apparatus comprising a computer processor, a computer memory operatively coupled to the computer processor, the computer memory having disposed within it computer program instructions capable of:
receiving, by a presence information server, a request message to administer presence information of the presentity in a presence information document, the presence information document implemented as a markup document that includes one or more dedicated sections for presence information of the presentity, the request message identifying an action to administer presence information in the presence information document, and an identification of a dedicated section;
retrieving, by the presence information server in response to the request message, the presence information document; and
modifying, by the presence information server, the presence information document, including administering, in accordance with the request message, the presence information of the presentity in the presence information document.

2. The apparatus of claim 1 wherein:
the request message to administer presence information of the presentity in a presence information document further comprises an HTTP PUT request message having a message body that includes the presence information of the presentity and a uniform resource identifier (‘URI’) that identifies a new dedicated section of the presence information document; and
administering, by the presence information server in accordance with the request message, the presence information of the presentity in the presence information document further comprises creating in the presence information document the new dedicated section identified by the URI and inserting into the new dedicated section the presence information contained in the message body of the HTTP PUT request message.

3. The apparatus of claim 1 wherein:
the request message to administer presence information of the presentity in a presence information document further comprises an HTTP GET request message and a URI that identifies a dedicated section of the presence information document; and
administering, by the presence information server in accordance with the request message, the presence information of the presentity in the presence information document further comprises retrieving, from the dedicated section identified by the URI, the presence information.

4. The apparatus of claim 1 wherein:
the request message to administer presence information of the presentity in a presence information document further comprises an HTTP POST request message having a message body that includes updated presence information of the presentity and a URI that identifies a dedicated section of the presence information document; and
administering, by the presence information server in accordance with the request message, the presence information of the presentity in the presence information document further comprises inserting in the dedicated section identified by the URI the updated presence information contained in the message body of the HTTP POST request message.

5. The apparatus of claim 1 wherein:
the request message to administer presence information of the presentity in a presence information document further comprises an HTTP DELETE request message and a URI that identifies a dedicated section of the presence information document; and
administering, by the presence information server in accordance with the request message, the presence information of the presentity in the presence information document further comprises removing from the presence information document the dedicated section identified by the URI.

6. The apparatus of claim 1 further comprising computer program instructions capable of:
receiving, by the presence information server, a request message to create the presence information document for the presentity;
creating, by the presence information server in response to receiving the request message, the presence information document for the presentity; and
storing the presence information document in the presence information server.

7. The apparatus of claim 6 wherein:
the request message to create the presence information document further comprises an HTTP PUT request message and a URI that identifies the presence information document; and
creating, by the presence information server in response to receiving the request message, the presence information document for the presentity further comprises implementing the presence information document as a markup document identified by the URI.

8. The apparatus of claim 1 further comprising computer program instructions capable of:
receiving, by the presence information server, a request message to delete the presence information document for the presentity; and
deleting, by the presence information server in response to receiving the request message, the presence information document for the presentity.

9. The apparatus of claim 8 wherein:
the request message to delete the presence information document further comprises an HTTP DELETE request message and a URI that identifies the presence information document; and
deleting, by the presence information server in response to receiving the request message, the presence information document for the presentity further comprises identifying, in dependence upon the URI, the presence information document stored in the presence information server and removing the identified presence information document from the presence information server.

10. An apparatus for managing presence information of a presentity through a network according to a loosely-coupled network architecture style, the presentity representing a user of the network, the apparatus comprising a computer processor, a computer memory operatively coupled to the computer processor, the computer memory having disposed within it computer program instructions capable of:
receiving, by a presence information server, a request message to create a presence information document for the presentity, the request message to create the presence information document further comprising an HTTP PUT request message and a URI that identifies the presence information document;
creating, by the presence information server in response to receiving the request message, the presence information document for the presentity, including implementing the presence information document as a markup document identified by the URI;
storing the presence information document in the presence information server;
receiving, by the presence information server, a request message to administer presence information of the presentity in the presence information document, the presence information document implemented as a markup document that includes one or more dedicated sections for presence information of the presentity, the request message identifying an action to administer presence information in the presence information document, and an identification of a dedicated section;
retrieving, by the presence information server in dependence upon the request message, the presence information document;
if the request message to administer presence information of the presentity in the presence information document comprises an HTTP GET request message and a URI that identifies a dedicated section of the presence information document:
modifying, by the presence information server, the presence information document, including administering, in accordance with the request message, the presence information of the presentity in the presence information document including retrieving, from the dedicated section identified by the URI, the presence information;
if the request message to administer presence information of the presentity in the presence information document comprises an HTTP POST request message having a message body that includes updated presence information of the presentity and a URI that identifies a dedicated section of the presence information document:
modifying, by the presence information server, the presence information document, including administering, in accordance with the request message, the presence information of the presentity in the presence information document including inserting in the dedicated section identified by the URI the updated presence information contained in the message body of the HTTP POST request message;
if the request message to administer presence information of the presentity in the presence information document comprises an HTTP DELETE request message and a URI that identifies a dedicated section of the presence information document:
modifying, by the presence information server, the presence information document, including administering, in accordance with the request message, the presence information of the presentity in the presence information document removing from the presence information document the dedicated section identified by the URI;
receiving, by the presence information server, a request message to delete the presence information document for the presentity; the request message to delete the presence information document further comprising an HTTP DELETE request message and a URI that identifies the presence information document; and
deleting, by the presence information server in response to receiving the request message, the presence information document for the presentity including identifying, in dependence upon the URI, the presence information document stored in the presence information server and removing the identified presence information document from the presence information server.

11. A computer program product for managing presence information of a presentity through a network according to a loosely-coupled network architecture style, the presentity representing a user of the network, the computer program product disposed in a computer readable, signal bearing medium, the computer program product comprising computer program instructions capable of:
receiving, by a presence information server, a request message to administer presence information of the presentity in a presence information document, the presence information document implemented as a markup document that includes one or more dedicated sections for presence information of the presentity, the request message identifying an action to administer presence information in the presence information document, and an identification of a dedicated section;
retrieving, by the presence information server in response to the request message, the presence information document; and
modifying, by the presence information server, the presence information document, including administering, in accordance with the request message, the presence information of the presentity in the presence information document.

12. The computer program product of claim 10 wherein the signal bearing medium comprises a recordable medium.

13. The computer program product of claim 10 wherein the signal bearing medium comprises a transmission medium.

14. The computer program product of claim 10 wherein:
the request message to administer presence information of the presentity in a presence information document further comprises an HTTP PUT request message having a message body that includes the presence information of the presentity and a uniform resource identifier (‘URI’) that identifies a new dedicated section of the presence information document; and
administering, by the presence information server in accordance with the request message, the presence information of the presentity in the presence information document further comprises creating in the presence information document the new dedicated section identified by the URI and inserting into the new dedicated section the presence information contained in the message body of the HTTP PUT request message.

15. The computer program product of claim 10 wherein:
the request message to administer presence information of the presentity in a presence information document further comprises an HTTP GET request message and a URI that identifies a dedicated section of the presence information document; and
administering, by the presence information server in accordance with the request message, the presence information of the presentity in the presence information document further comprises retrieving, from the dedicated section identified by the URI, the presence information.

16. The computer program product of claim 10 wherein:
the request message to administer presence information of the presentity in a presence information document further comprises an HTTP POST request message having a message body that includes updated presence information of the presentity and a URI that identifies a dedicated section of the presence information document; and
administering, by the presence information server in accordance with the request message, the presence information of the presentity in the presence information document further comprises inserting in the dedicated section identified by the URI the updated presence information contained in the message body of the HTTP POST request message.

17. The computer program product of claim 10 wherein:
the request message to administer presence information of the presentity in a presence information document further comprises an HTTP DELETE request message and a URI that identifies a dedicated section of the presence information document; and
administering, by the presence information server in accordance with the request message, the presence information of the presentity in the presence information document further comprises removing from the presence information document the dedicated section identified by the URI.

18. The computer program product of claim 10 further comprising computer program instructions capable of:
receiving, by the presence information server, a request message to create the presence information document for the presentity;
creating, by the presence information server in response to receiving the request message, the presence information document for the presentity; and
storing the presence information document in the presence information server.

19. The computer program product of claim 17 wherein:
the request message to create the presence information document further comprises an HTTP PUT request message and a URI that identifies the presence information document; and
creating, by the presence information server in response to receiving the request message, the presence information document for the presentity further comprises implementing the presence information document as a markup document identified by the URI.

20. The computer program product of claim 10 further comprising computer program instructions capable of:
receiving, by the presence information server, a request message to delete the presence information document for the presentity; and
deleting, by the presence information server in response to receiving the request message, the presence information document for the presentity.

21. The computer program product of claim 19 wherein:
the request message to delete the presence information document further comprises an HTTP DELETE request message and a URI that identifies the presence information document; and
deleting, by the presence information server in response to receiving the request message, the presence information document for the presentity further comprises identifying, in dependence upon the URI, the presence information document stored in the presence information server and removing the identified presence information document from the presence information server.
